(19) United States
(12) Patent Application Publication
(10) Pub. No.: US 2023/0214058 A1
(43) Pub. Date: Jul. 6, 2023

(54) CONTROLLING OPTICAL SENSORS IN A DISPLAY

(71) Applicant: Microsoft Technology Licensing, LLC, Redmond, WA (US)

(72) Inventors: Samu Matias KALLIO, Redmond, WA (US); Yichen TANG, Redmond, WA (US)

(21) Appl. No.: 17/565,832

(22) Filed: Dec. 30, 2021

(51) Int. Cl. G06F 3/041; G06F 3/042; G09G 5/12; G09G 3/3208

(52) U.S. Cl. CPC G06F 3/04184; G06F 3/0421; G09G 5/12; G06F 3/0412; G09G 2310/0243; G09G 3/3208; G09G 2360/14; G09G 2310/08

(57) ABSTRACT

Interference of light-sensing elements of a display system by light-emitting elements of the display system is reduced. An emission schedule is determined for the one or more light-emitting elements in an optical sensing region of the display system to include one or more emission periods and one or more emission-off periods, wherein the one or more light-emitting elements emit light within the optical sensing region during an emission period and do not emit light within the optical sensing region during an emission-off period. A synchronization signal is generated to drive the one or more light-emitting elements of the display system. Light sensing by the one or more light-sensing elements in the optical sensing region is triggered, based on the emission schedule, wherein the sensing by the light-sensing elements in the optical sensing region is triggered to be performed during the emission-off period.

### BACKGROUND

Modern computing devices are often equipped with touchscreen displays and sensors that turn off the displays in various contexts. For example, a mobile communications device may turn off the display during a phone call while the device is positioned near the user's ear. Optical sensors can detect this condition (e.g., proximity to the user's head) and trigger the display to turn off. In another example, such sensors can be used to detect ambient light conditions (e.g., so as to turn down the display brightness in dark rooms).

### SUMMARY

The described technology reduces interference of one or more light-sensing elements of a display system by one or more light-emitting elements of the display system. An emission schedule is determined for the one or more light-emitting elements in an optical sensing region of the display system to include one or more emission periods and one or more emission-off periods, wherein the one or more light-emitting elements emit light within the optical sensing region during an emission period and do not emit light within the optical sensing region during an emission-off period. A synchronization signal is generated to drive the one or more light-emitting elements of the display system. Light sensing by the one or more light-sensing elements in the optical sensing region is triggered, based at least in part on the emission schedule, wherein the sensing by the light-sensing elements in the optical sensing region is triggered to be performed during the emission-off period.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. lillustrates an example computing device with touchscreen displays having synchronized light-emitting and light-sensing elements.

FIG. 2 illustrates a cross-sectional view of an optical sensor region of an example touchscreen display with at least one layer of light-emitting elements positioned between a cover glass and at least one layer of light-sensing elements.

FIG. 3 illustrates components of an example touchscreen display system with synchronized light-emitting and light-sensing elements.

FIG. 4 illustrates elements of an example timing generator circuit.

FIG. 5 illustrates two example timing diagrams.

FIG. 6 illustrates example operations for synchronizing light-emitting and light-sensing elements in a display.

FIG. 7 illustrates an example computing device for use in refining a neural network system.

### DETAILED DESCRIPTIONS

Optical sensors (also referred to as light-sensing elements) may be used to detect the proximity of a user's head or the ambient light conditions and tend to be placed in the bezel regions of a mobile device. A bezel sits between the display area and the edges of the device. However, modern industrial design requirements continue to pressure product designers to minimize the bezel areas of mobile devices.

The described technology provides integrated control between the optical sensors and the light-emitting elements of the display to allow the optical sensors to operate effectively from beneath or near the light-emitting elements of the display. By moving the optical sensors beneath the light-emitting elements, the optical sensors no longer occupy an area in the bezels, allowing for smaller bezels. However, without the described technology, the light produced by the light-emitting elements can interfere with accurate sensing of ambient/proximate light conditions by the optical sensors. Accordingly, the described technology synchronizes the operation of the light-emitting elements relative to the operation of the optical sensors to avoid such interference, thus improving the accuracy of such sensors. In other implementations, the optical sensors can be used to detect images, such in the case of under-display cameras and fingerprint detectors, and reducing light interference in such applications has technical benefits for accurate image detection. In addition to ambient light detection, camera-like image detection, fingerprint detection, the described technology may also be used for proximity detection, which can benefit by reducing false proximity readings caused by light interference contributed from light-emitting elements of the electronic device.

FIG. 1 illustrates an example computing device 100 with touchscreen displays having synchronized light-emitting and light-sensing elements in optical sensing regions. The illustrated computing device 100 includes two touchscreen displays that are movably separated by a hinge 102, although the described technology may be employed in any number of displays (i.e., one or more displays). The touchscreen display 104 includes an optical sensing region 106 near an edge of the display surface, and the touchscreen display 108 includes an optical sensing region 110 near an edge of the display surface. As shown, the illuminated display regions of both touchscreen displays extend substantially to the edges of the display surface, presenting minimal or non-existent bezel regions around the displays. Accordingly, the optical sensing regions are illustrated as being positioned beneath the display layers of the illuminated display regions of the touchscreen displays rather than in any bezel regions.

To reduce or eliminate light-induced interference between the light-emitting elements of a touchscreen display and the light-sensing elements of the optical display region of the touchscreen display, a display controller uses an emission schedule and a synchronization signal to coordinate the duty cycles of the elements such that the light-emitting elements are turned off while the light-sensing elements are turned on. Accordingly, the synchronization signals trigger the beginning of each frame (vertical refresh). Each horizontal refresh within a frame is managed by the display controller's internal clock by following predefined timing parameters, although other configurations may be employed.

In addition, in at least one implementation, secondary light-emitting elements and secondary light-sensing elements, such as infrared light sources and sensors. In such cases, the activation of the secondary light-emitting elements during an emission time of primary light-emitting elements (e.g., the visible light-emitting elements used to render text and/or graphics on the display screen) can cause interference in the visible display (e.g., causing visible artifacts in the display). As such, the described technology can also be used to synchronize the activation of the secondary light-emitting elements to the emission-off period of the primary light-emitting elements discussed above. In some such scenarios, the secondary light-sensing elements can be active during both emission and emission-off periods of the primary light-emitting elements.

In the infrared scenario, infrared light-sensing elements and the associated infrared light-emitting elements may be used in a time-of-flight sensing operation to determine the distance of an object from the display. For example, the infrared light-emitting elements emit infrared light, which bounces off an object in the ambient environment. The bounced light is sensed by the infrared light-sensing elements. The difference between the infrared light emission and the infrared light sensing of the bounced light is referred to as “time-of-flight,” which can be used to determine the distance of an object from the display based at least in part on the speed of light (e.g., for proximity sensing). By limiting activation of the infrared light-emitting elements to the emission-off period of the visible light-emitting elements, this approach provides a technical advantage that reduces or eliminates light interference from the infrared light-emitting elements with the visible light-emitting elements. Furthermore, activation of the infrared light-emitting elements can also be limited to the emission-off period of the visible light-emitting elements so as to limit or eliminate interference with the visible light-emitting elements.

In some implementations involving multiple displays, the synchronization of the light-emitting elements and the light-sensing elements can differ. For example, in an implementation in which the two displays can be unfolded completely open (such that the back surfaces of the displays are facing each other), the light-emitting elements of one display can be active while the light-emitting elements of the other display are inactive for long periods of time. In this example, light-sensing may not be considered beneficial enough (e.g., in power consumption) for the display with the inactive light-emitting elements. As such, while one display is synchronizing activation of light-emitting elements and light-sensing elements, the light-emitting elements and light-sensing elements of the other display are independently deactivated during these periods of time. In another example, the optical sensing regions of each display may be positioned in different locations on the display surface. As such, the timing of light-sensing element activation in one display can be different than in the other display to align with emission-off periods at the different display locations. Other variations of synchronization between different displays are also contemplated. Accordingly, in some implementations, the sensor trigger signals directed to the light-sensing elements and the synchronization signals directed to the light-emitting elements of different displays can be independent of or otherwise different from each other (e.g., with respect to those of another display) to accommodate these variations of synchronization.

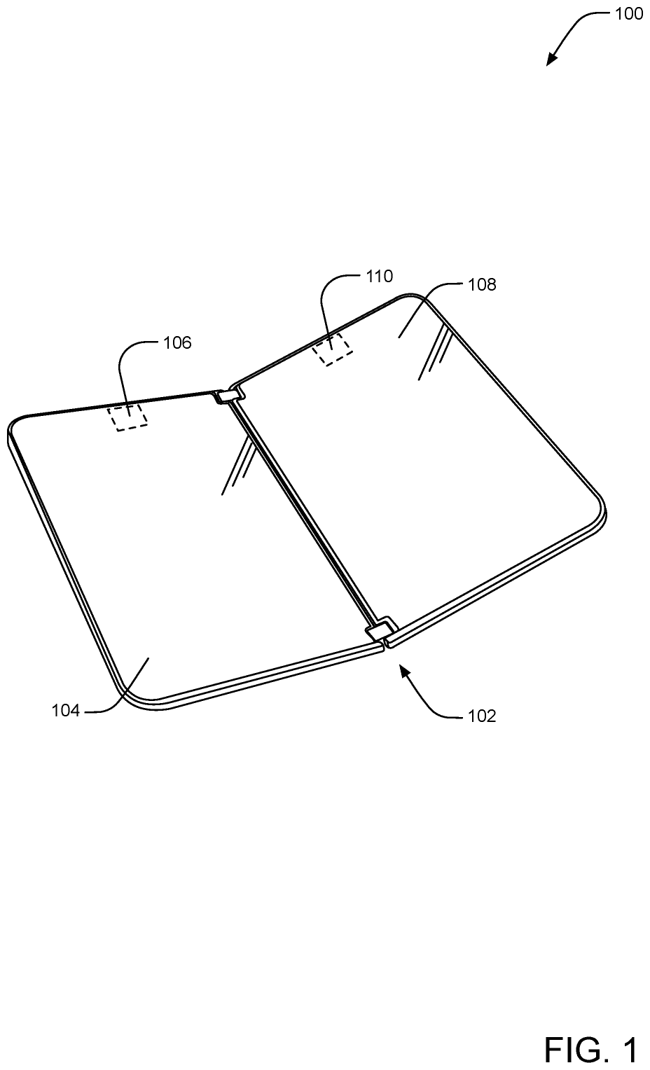

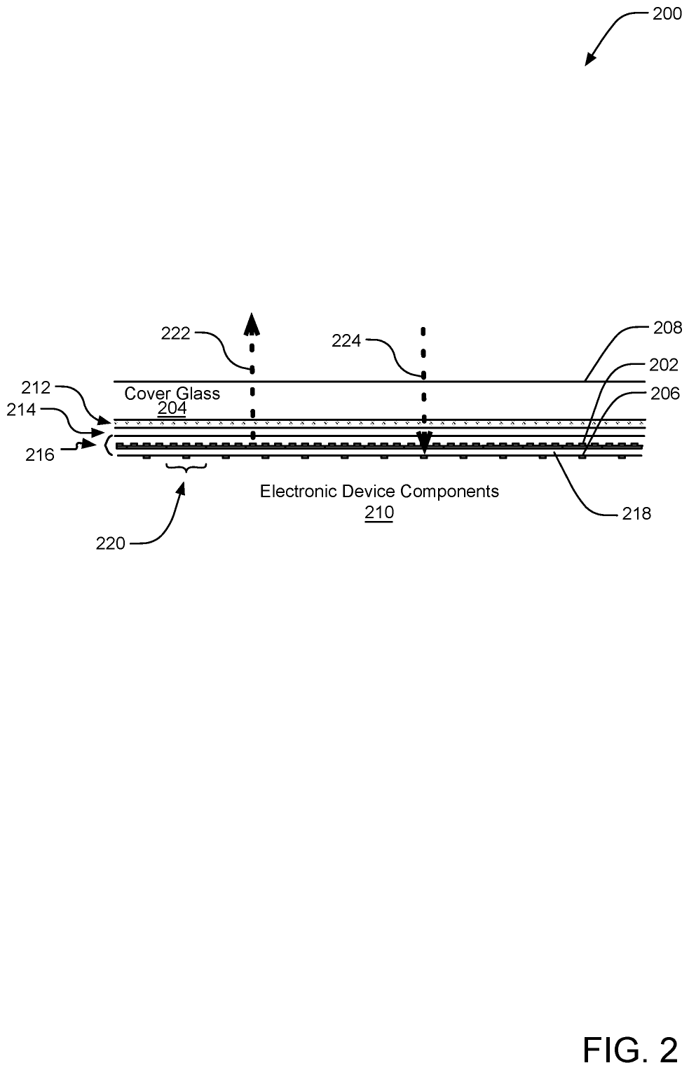

FIG. 2 illustrates a cross-sectional view of an optical sensor region of an example touchscreen display 200 with at least one layer of light-emitting elements (such as light-emitting element 202) positioned between a cover glass 204 and at least one layer of light-sensing elements (such as light-sensing element 206). In FIG. 2, an electronic device employing the described technology could be a mobile computing device (such as the example shown in FIG. 1), although other electronic devices may include without limitation tablet computers, electronic displays, laptop computers, all-in-one computers, electronic accessories, building security devices, automated teller machines, etc. The electronic device includes a display, which may or may not include touchscreen functionality in various other implementations.

The example touchscreen display 200 includes a stack of components between a surface 208 of the touchscreen display 200 and internal electronic device components 210 of the electronic device. In the illustrated example, the stack includes the cover glass 204, a polarizing layer 212, one or more quarter wavelength plate(s) 214, and a light-sensing/emitting layer 216. In one implementation, the light-sensing/emitting layer 216 may include multiple sublayers and organic light-emitting diodes (OLEDs) positioned on a transparent or translucent substrate 218. An OLED sublayer may include transparent or translucent regions, which can allow light to pass through sublayers of the light-sensing/emitting layer 216. Other layers of components may be employed in the stack, including without limitation electrically-resistive layers, capacitive touchscreen layers, and surface acoustic wave layers. Other electronic device components 210 are shown immediately below the touchscreen display 200, although intervening layers may exist.

In one implementation, the light-sensing/emitting layer 216 includes an array of pixels, such as a pixel 220, wherein each pixel includes at least one light-emitting element, such as the light-emitting element 202. Regions of the touchscreen display 200 acting as an optical sensor region also include at least one light-sensing element, such as a light-sensing element 206, which may also be configured as part of a pixel in an optical sensing region. In the implementation of the light-sensing/emitting layer 216, each pixel in the optical sensor region is shown as including three light-emitting elements (e.g., red, green, and blue) and a light-sensing element, although other configurations are contemplated. As shown, the light-sensing elements and light-emitting elements of each pixel are configured in different sublayers or planes (e.g., to provide a higher light-emitting pixel density), although in other implementation, such elements may be positioned in the same layer (e.g., allowing for a thinner display stack while potentially constraining the pixel density). By configuring a single pixel to include light-sensing elements and light-emitting elements in different sublayers, the touchscreen display 200 can provide overlapping light-sensing and light-emitting functionality without substantially increasing the thickness of the display or substantially decreasing the resolution and/or illumination of the touchscreen display 200.

In the example of FIG. 2, light emitted by one of the light-emitting elements passes through the cover glass 204 substantially in a direction 222 and into the ambient environment (although in some implementations, some of the emitted light is directed in multiple directions, including back into the electrical device opposite to the direction 222). In contrast, light sensed by the light-sensing elements is substantially received from the direction 224, some of which passes through the cover glass 204. However, light emitted by the light-emitting elements can also be received by the light-sensing elements, whether directly from the light-emitting element or via internal reflection from other components in the stack. Accordingly, by synchronizing the light-emitting elements to deactivate (e.g., turn off) during an emission-off period in which the light-sensing elements are active (e.g., turned on), interference by emitted light can be dramatically reduced or eliminated.

In other implementations, a display may include light-emitting elements and light-sensing elements in the same layer, rather than the light-emitting elements occupying a layer between a layer of light-sensing elements and the cover glass 204. In yet other implementations, a layer of light-sensing elements may be positioned between a layer of light-emitting elements and the cover glass 204. While positioning light-sensing elements and light-emitting elements on different layers can provide a tighter light-emitting pixel density and a thinner display stack, positioning light-sensing elements and light-emitting elements on the same layer can provide a thinner display stack, potentially at the expense of light-emitting pixel density.

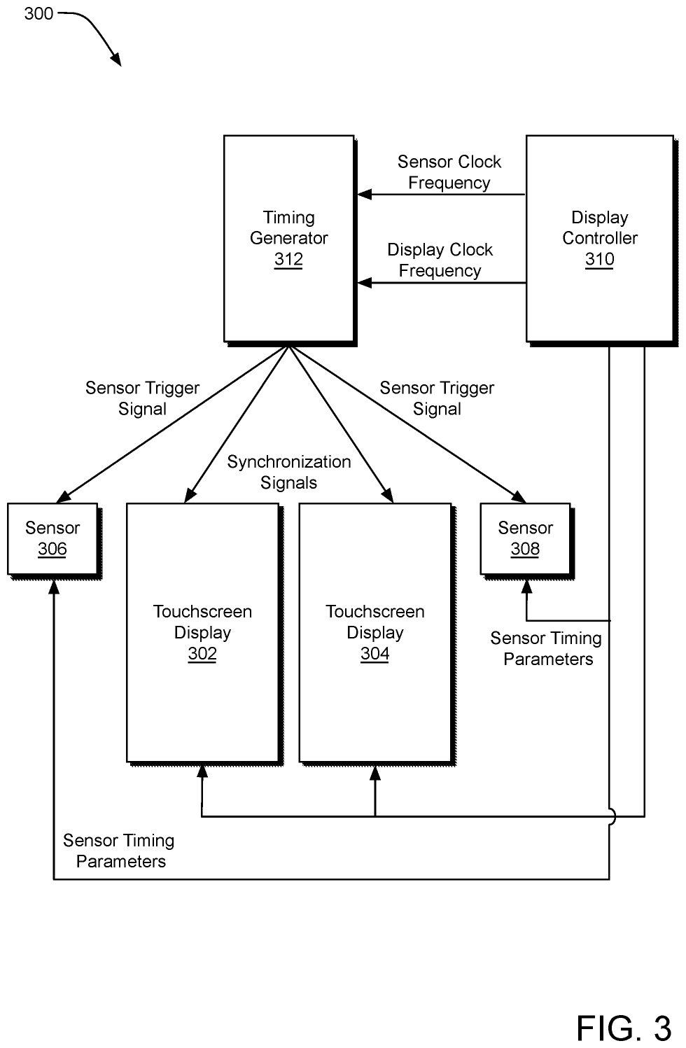

FIG. 3 illustrates components of an example touchscreen display system 300 with synchronized light-emitting and light-sensing elements. FIG. 3 is illustrated and described with regard to a two-display-screen configuration, but the described technology also applies to configurations with a single display screen and configurations with more than two display screens.

A touchscreen display 302 and a touchscreen display 304 are presented in FIG. 3. Each touchscreen display may be associated with a set of light-sensing elements positioned within an optical sensing region of each touchscreen display, as represented by a sensor 306 and a sensor 308, respectively. A display controller 301 manages the operation of the touchscreen displays and the synchronization between the light-sensing elements (e.g., in the sensor 306 and the sensor 308) and the emission-off periods of the optical sensing region of the corresponding touchscreen displays. In some implementations, a separate or integrated sensor controller may also be employed to manage the activation of the light-sensing elements.

The display controller 310 sets, in a timing generator 312, the display clock frequency for the touchscreen displays. The timing generator 312 sends a synchronization signal to both touchscreen displays based at least in part on the display clock frequency, synchronizing the display of content from the host on each touchscreen display. The display clock frequency is used as a basis for the horizontal scan rate, which is the total number of horizontal lines per second, including blanking, and the vertical refresh rate, which is the number of screen refreshes per second, including blanking. Blanking is the period between each line scan (horizontal blanking) and each frame (vertical blanking). Accordingly, the synchronization signals are derived from the display clock and drive the horizontal and vertical pixels displayed within the display screen. Furthermore, a display can experience multiple emission-off periods per vertical refresh (e.g., between horizontal line scans, between adjacent vertical refreshes). The display controller 310 also sets touchscreen parameters, such as vertical and horizontal refresh rates and blanking period durations.

The display controller 310 also sets the sensor clock frequency in the timing generator 312. For example, the sensor clock frequency may be set to a number of pulses times the display clock frequency, although other settings are contemplated. The sensor clock frequency is intended to position the sensor activations within select emission-off periods, and in some implementations, at specific temporal locations and durations during the select emission-off periods. The activations of the sensors (which may be independent of each other) are triggered in synchronization with sensor trigger signals provided to the sensors by the timing generator 312, based at least in part on the sensor clock frequency.

Applying sensor trigger signals to light-sensing elements and synchronization signals to light-emitting elements, based on display and sensor clock frequencies, allows the timing generator 312 to synchronize the light-sensing elements and light-emitting elements of a display independently, based on the unique characteristics of the display and its operations and/or context. Likewise, in multiple display configurations, the timing generator 312 can also synchronize the elements of a different display independently, based on the unique characteristics of the corresponding display and its operations and/or context. For example, the light-emitting elements and light-sensing elements of different displays may be activated at different frequencies. Moreover, in at least one implementation, the timing generator 312 is a hardware component or circuitry that provides sufficient precision to synchronize sensing and emitting in high-refresh-rate displays used in modern electronic devices.

In addition to positioning the sensor activations within emission-off periods, some implementations of the display controller 310 may also set sensor timing parameters, including without limitation a delay time and a duration. In one implementation, delay time represents the period of time after receiving a sensor trigger signal from the timing generator 312 before the sensor is activated. For example, the display content of an optical sensing region may be very bright—the delay period allows time for the bright emission and associated reflections to dissipate after the light-emitting pixels are deactivated before turning on the sensors. The duration represents the period of time after activation before the sensors are deactivated (e.g., still within the emission-off period). For example, a sensor activated after a longer delay period may be set for a shorter duration in order to deactivate before the emission-off period ends. Note that the sensor timing parameters for one sensor may be different from those of another sensor. Furthermore, the sensor timing parameters may vary depending on display content (e.g., bright content versus dark content) and location on the screen.

It should also be understood that because a display can experience multiple emission-off periods per vertical refresh, a sensor may activate multiple times per frame. For example, light-sensing elements can have a very short integration time (e.g., 0.5 ms), so the sampling frequency can be very fast (e.g., 2 MHz). Moreover, a display may be driven with multiple duty pulses per frame, depending on the display panel refresh rate, during which the very short integration time of the light-sensing elements may be scheduled. Accordingly, the display can present multiple emission-off periods per frame. In this manner, changes in ambient light can be accurately detected more frequently than merely with each vertical refresh, providing quicker responses to such changes (e.g., more quickly dimming or brightening a display) than other implementations.

In one example, a sensor may require multiple samples (e.g., perhaps tens of samples) to collect enough light for its computation (e.g., proximity detection, ambient light detection, image detection) by setting a sensor sampling rate of 4 samples per 60 Hz display frame (i.e., every 16.7 ms), the sensor reporting rate can be increased over a single sensing period per frame. Specifically, in an example of 4 sensor samples per frame, it would take about 125 ms to collect 30 sensor samples at a 60 Hz display refresh rate. As a result, an implementation with multiple sensor integration periods per frame would be able to report its sensed data more quickly than an implementation with a single sensor integration period per frame. In another example relating to a camera type of use, multiple sensor integration periods per frame can improve image sharpness, particularly in the presence of object or camera motion, as compared to a single sensor integration period per frame.

In yet another implementation, the light-sensing elements may be activated longer than the duration of a single emission-off period. For example, although the light-sensing elements are activated during light emission, only data from the emission-off period would be used to

In some implementations, a sensor controller (separate from or integrated into the display controller 310) may manage (e.g., set or modify) the sensor clock frequency and any sensor timing parameters. Moreover, in some implementations, light-emitting elements and light-sensing elements may be integrated into a single component. For example, some optical elements may be switchable between sensing and emitting operation. In such arrangements, an optical component, when configured to emit light, is deemed a light-emitting element, and the same optical element, when configured to sense light, is deemed a light-sensing element.

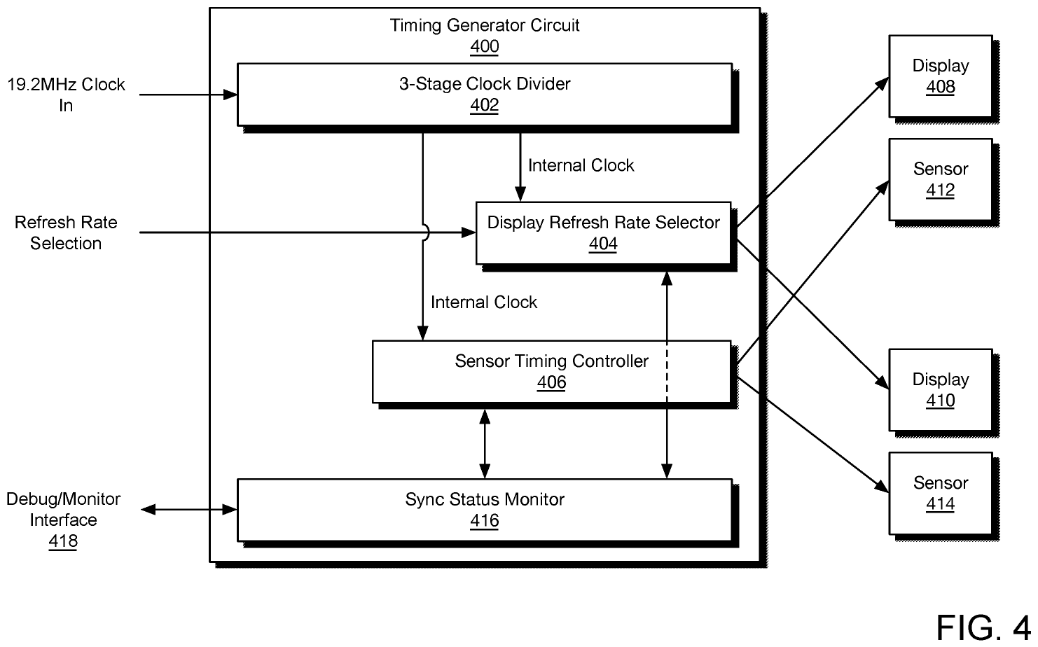

FIG. 4 illustrates elements of an example timing generator circuit 400. Alternative timing generators may include different elements and different combinations of hardware and software. Implementing a timing generator with hardware components can increase the precision of the synchronization between light emitters and light sensors.

The timing generator circuit 400 receives a 19.2 MH clock input into a 3-stage clock divider 402, which generates an internal clock. The internal clock is input to a display refresh rate selector 404 and a sensor timing controller 406. It should be understood that the display refresh rate selector 404 and the sensor timing controller 406 may also receive additional timing parameters, such as from a display controller (see FIG. 3).

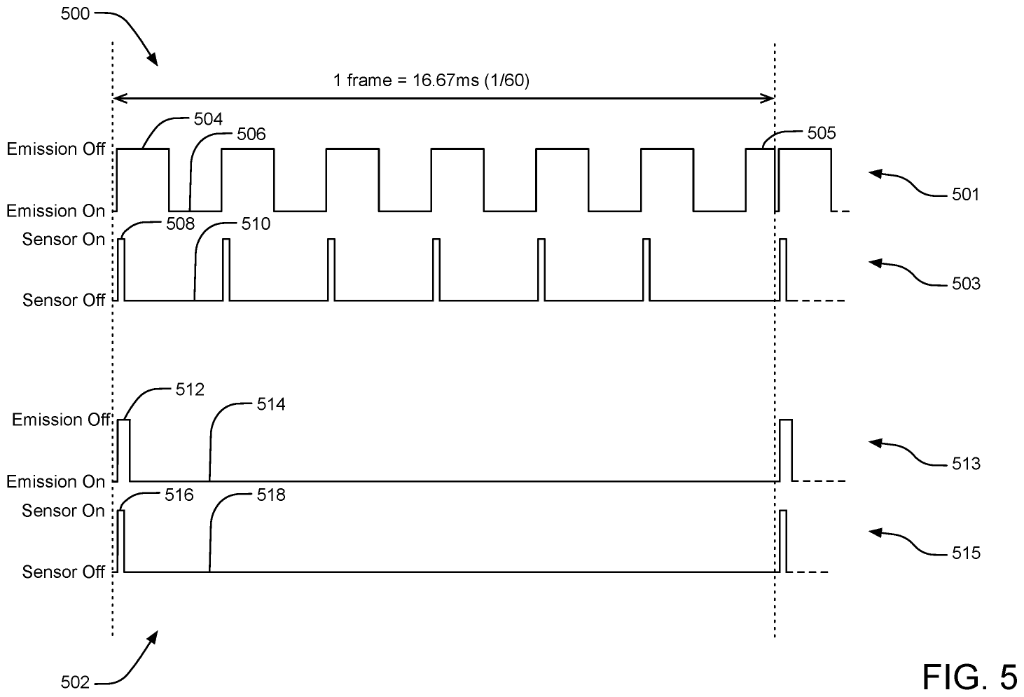

In one implementation, the display refresh rate selector 404 receives the internal clock and a refresh rate selection and generates independent synchronization signals that are sent to the light-emitting elements of the display 408 and the display 410, although in other implementations, the synchronization signals may be identical to each other or otherwise mutually dependent in some fashion. As shown in FIG. 5, these synchronization signals trigger the displays between emission-on and emission-off periods.

The sensor timing controller 406 receives the internal clock and generates independent sensor trigger signals that are sent to the light-sensing elements of the sensor 412 and the sensor 414, although in other implementations, the sensor trigger signals may be identical to each other or otherwise mutually dependent in some fashion. As shown in FIG. 5, these sensor trigger signals trigger a sensor into integration periods during which light sensing is activated in synchronization with the emission-off periods of a corresponding display. It should be understood that additional timing parameters (e.g., sensor delay and duration parameters, parameters influencing vertical and/or horizontal refreshes) may also be applied (e.g., to adjust the placement of the sensor integration period at a desired position within an emission-free period of a corresponding display).

A sync status monitor 416 communicates with the display refresh rate selector 404 and the sensor timing controller 406 to monitor and/or control display and sensor timings. Accordingly, the timing generated by the timing generator circuit 400 can be configured, monitored, and/or debugged through a debug/monitor interface 418.

It should be understood that FIG. 4 illustrates an example timing generator for a dual-display device and that other implementations may be employed for a single display device or a device supporting more than two displays or display components.

FIG. 5 illustrates two example timing diagrams. The examples are provided given a single frame period of 16.67 ms.

A timing diagram 500 illustrates an example of multiple sensor integration periods and multiple display emission-off periods per frame (e.g., when pulse width modulated dimming is enabled and display emission-on periods occur at 360 Hz). The timing diagram 500 shows a display timing signal 501, indicating emission-off periods (e.g., emission-off period 504) and emission-on periods (e.g., emission-on period 506), and a sensor timing signal 503, indicating the sensor integration (sensor-on) periods in which light-sensing elements are activated (e.g., sensor integration period 508) and the sensor-off period (e.g., sensor-off period 510). In this example, each frame of the display includes six sensor integration periods. In some implementations, the start and duration of the sensor integration period with respect to the emission-off period of the corresponding display may be adjusted by sensor timing parameters provided by a display controller (or a sensor controller).

An adjustable extension period 505 (an example display timing parameter), during which display emissions are off, is shown at the end of the frame to align the emission-on/off periods of the subsequent frame with the frame refresh boundary. In this implementation, the synchronization of sensor and display periods accommodates adjustable extension periods of each frame so that the sensor and display periods are correctly aligned in subsequent frames, regardless of the duration of the adjustable extension period.

Another timing diagram 502 illustrates an example of a single sensor integration period and a single display emission-off period per frame (e.g., when pulse width modulated dimming is not enabled and the display emission-on period occupies almost the entire frame). The timing diagram 502 shows a display timing signal 513, indicating an emission-off period 512 and an emission-on period 514, and a sensor timing signal 515, indicating a sensor integration (sensor-on) period 508 in which light-sensing elements are activated and a sensor-off period 510. In some implementations, the start and duration of the sensor integration period with respect to the emission-off period of the corresponding display may be adjusted by timing parameters provided by a display controller.

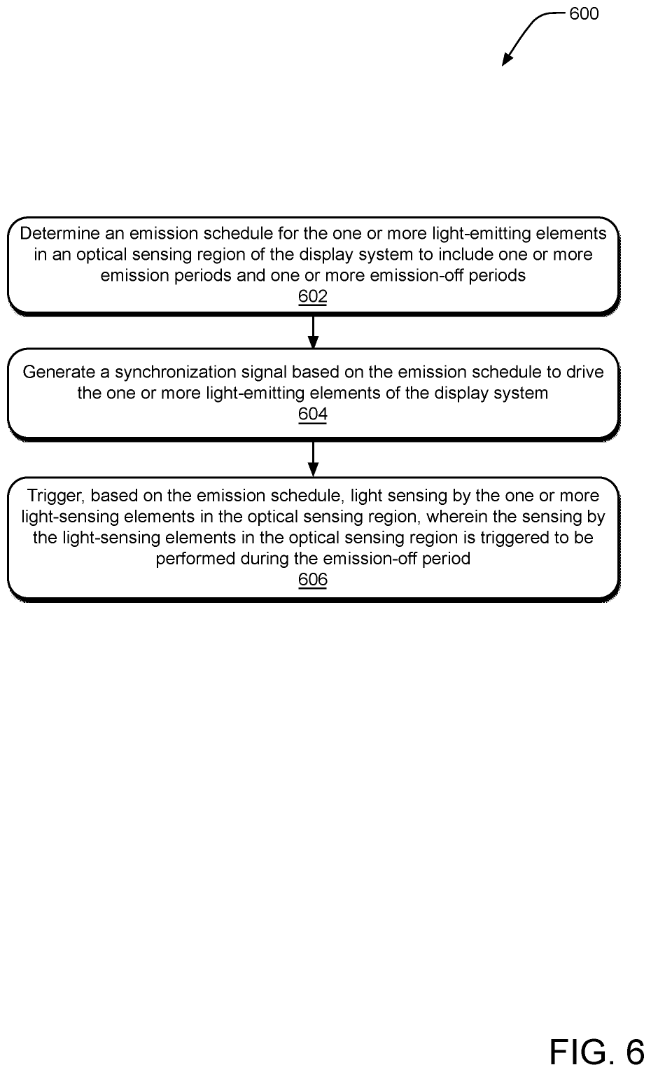

FIG. 6 illustrates example operations 600 for synchronizing light-emitting and light-sensing elements in a display. A scheduling operation 602 determines an emission schedule for the one or more light-emitting elements in an optical sensing region of the display system to include one or more emission periods and one or more emission-off periods. The emission schedule manages the activation and deactivation of the light-emitting elements using a synchronization signal, such that the one or more light-emitting elements emit light within the optical sensing region during an emission period and do not emit light within the optical sensing region during an emission-off period. The synchronization signal, for example, may be used to activate vertical refreshes, in which horizontal refreshes are controlled by internal timing as managed by a display controller.

A generating operation 604 generates a synchronization signal based at least in part on the emission schedule to drive the one or more light-emitting elements of the display system. In one implementation, the synchronization signal is also based at least in part on the clock frequency of the display. A display system may include one or more displays, which may be touchscreen displays or non-touchscreen displays.

A triggering operation 606 triggers light sensing by the one or more light-sensing elements in the optical sensing region of the display. In one implementation, a timing generator issues a sensor trigger signal to a sensor in the optical sensing region to activate the sensor. The triggering is based at least in part of the emission schedule to coincide with the emission-off periods of the light-emitting elements. The triggering may also be based at least in part on the sensor clock frequency and/or the display clock frequency, such as triggering relative to vertical refreshes and horizontal refreshes with various delays and/or durations for the sensors, which may be provided by the display controller or a sensor controller. For example, the display controller may introduce an activation delay after the receipt of a sensor trigger signal in order to allow the dissipation of light reflections from the light-emitting elements. Likewise, the display controller may set a duration of the sensor activation to ensure that the sensor is deactivated before the next emission period commences.

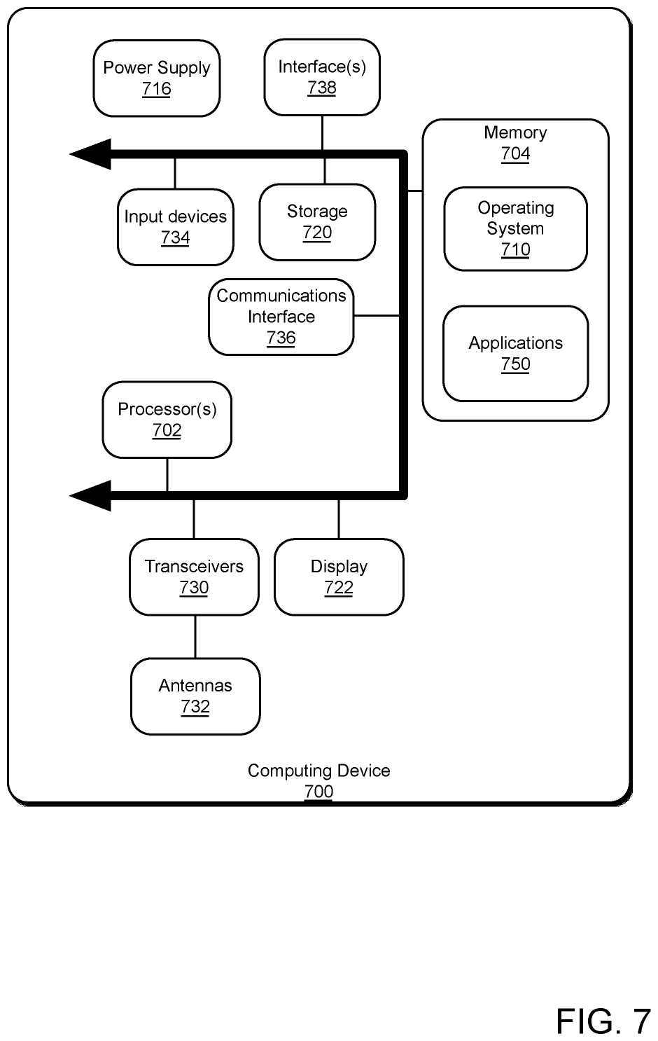

FIG. 7 illustrates an example computing device for use in reducing light interference in a display system. The computing device 700 may be a client device, such as a laptop, mobile device, desktop, tablet, or a server/cloud device. The computing device 700 includes one or more processor(s) 702, and a memory 704. The memory 704 generally includes both volatile memory (e.g., RAM) and nonvolatile memory (e.g., flash memory). An operating system 710 resides in the memory 704 and is executed by the processor(s) 702.

In an example computing device 700, as shown in FIG. 7, one or more modules or segments, such as applications 750; all or part of a communication interface, a display controller, a sensor controller, and a timing generator; and other modules are loaded into the operating system 710 on the memory 704 and/or storage 720 and executed by processor(s) 702. The storage 720 may store timing data, sensor measurements, and other data and be local to the computing device 700 or may be remote and communicatively connected to the computing device 700. In one implementation, the display controller, the sensor controllers, a communications interface, and/or a timing generator may include circuitry to perform intended functions. In particular, in one implementation, a hardware timing generator can assist in providing desired timing accuracy for synchronizing light-emitting and light-sensing elements in a display.

The computing device 700 includes a power supply 716, which is powered by one or more batteries or other power sources and which provides power to other components of the computing device 700. The power supply 716 may also be connected to an external power source that overrides or recharges the built-in batteries or other power sources.

The computing device 700 may include one or more communication transceivers 730, which may be connected to one or more antenna(s) 732 to provide network connectivity (e.g., mobile phone network, Wi-Fi®, Bluetooth®) to one or more other servers and/or client devices (e.g., mobile devices, desktop computers, or laptop computers). The computing device 700 may further include a network adapter 736, which is a type of communication device. The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard or mouse). These and other input devices may be coupled to the server by one or more interfaces 738, such as a serial port interface, parallel port, or universal serial bus (USB). The computing device 700 may further include a display 722, such as a touch screen display.

The computing device 700 may include a variety of tangible processor-readable storage media and intangible processor-readable communication signals. Tangible processor-readable storage can be embodied by any available media that can be accessed by the computing device 700 and includes both volatile and nonvolatile storage media, removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

An example method of reducing interference of one or more light-sensing elements of a display system by one or more light-emitting elements of the display system is provided. The method includes determining an emission schedule for the one or more light-emitting elements in an optical sensing region of the display system to include one or more emission periods and one or more emission-off periods, wherein the one or more light-emitting elements emit light within the optical sensing region during an emission period and do not emit light within the optical sensing region during an emission-off period. The method also includes generating a synchronization signal to drive the one or more light-emitting elements of the display system and triggering, based at least in part on the emission schedule, light sensing by the one or more light-sensing elements in the optical sensing region, wherein the light sensing by the light-sensing elements in the optical sensing region is triggered to be performed during the emission-off period. This method and related systems and storage media provide at least a technical benefit of reducing interference in an optical sensing region of a display.

Another example method of any preceding method is provided, wherein the display system includes at least one display having a stack of components, the stack of components including a cover glass and the one or more light-emitting elements, wherein the cover glass and the one or more light-emitting elements of the stack within the optical sensing region of the at least one display are positioned between the cover glass and the light-sensing elements of the at least one display. This method and related systems and storage media provide at least a technical benefit of smaller pixels compared to some other display stacks with sensors and emitters on the same layers.

Another example method of any preceding method is provided, wherein the display system includes at least one display having a stack of components, and the one or more light-emitting elements and the one or more light-sensing elements within the optical sensing region of the at least one display are positioned in a same layer of the stack. This method and related systems and storage media provide at least a technical benefit of a thinner display stack compared to some other display stacks with sensors and emitters on different layers

Another example method of any preceding method is provided, wherein the display system includes at least two displays, and the light-emitting elements and the light-sensing elements in the optical sensing region of each display are controlled based at least in part on the synchronization signal. This method and related systems and storage media provide at least a technical benefit of synchronization of light-emitting elements and light-sensing elements to reduce light interference in multiple displays.

Another example method of any preceding method is provided, wherein the display system includes at least a first display and a second display, and the light-sensing elements in the optical sensing region of the first display are triggered at a different time than the light-sensing elements in the optical sensing region of the second display. This method and related systems and storage media provide at least a technical benefit of independent synchronization of light-emitting elements and light-sensing elements to reduce light interference in multiple displays (e.g., different displays can be synchronized independently to accommodate different characteristics and uses).

Another example method of any preceding method is provided, wherein the light-emitting elements in the optical sensing region of the display system are activated and deactivated at different frequencies than the light-sensing elements in the optical sensing region of the display system. This method and related systems and storage media provide at least a technical benefit of accommodating different display refresh rates and sensing duration requirements and can further accommodate power savings by tuning operations of these elements (e.g., shorter or fewer sensor integration times can use less power).

Another example method of any preceding method further includes triggering, based at least in part on the emission schedule, light emission by one or more secondary light-emitting elements of the display system, wherein the light emission by the secondary light-emitting elements is triggered to be performed during the emission-off period. This method and related systems and storage media provide at least a technical benefit of reducing or eliminating interference caused by secondary light-emitting elements (e.g., infrared light-emitting elements) of a display with primary light-emitting elements (e.g., RGB light-emitting elements) of a display.

An example display system includes one or more light-sensing elements within an optical sensing region of the display system, one or more light-emitting elements within the optical sensing region of the display system, a timing generator including circuitry configured to generate a synchronization signal to drive the one or more light-emitting elements, and a display controller including circuitry configured to determine an emission schedule for the one or more light-emitting elements in the optical sensing region to include one or more emission periods and one or more emission-off periods. The one or more light-emitting elements emit light within the optical sensing region during an emission period and do not emit light within the optical sensing region during an emission-off period, wherein light sensing by the one or more light-sensing elements in the optical sensing region is triggered, based at least in part on the emission schedule, to be performed during the emission-off period.

Another example display system of any preceding system is provided, wherein the display system includes at least one display having a stack of components, the stack of components including a cover glass and the one or more light-emitting elements, wherein the cover glass and the one or more light-emitting elements of the stack within the optical sensing region of the at least one display are positioned between the cover glass and the light-sensing elements of the at least one display.

Another example display system of any preceding system is provided, wherein the display system includes at least one display having a stack of components, and the one or more light-emitting elements and the one or more light-sensing elements within the optical sensing region of the at least one display are positioned in a same layer of the stack.

Another example display system of any preceding system is provided, wherein the display system includes at least two displays, and the light-emitting elements and the light-sensing elements in the optical sensing region of each display are controlled based at least in part on the synchronization signal.

Another example display system of any preceding system is provided, wherein the display system includes at least a first display and a second display, and the light-sensing elements in the optical sensing region of the first display are triggered at a different time than the light-sensing elements in the optical sensing region of the second display.

Another example display system of any preceding system is provided, wherein the light-emitting elements in the optical sensing region of the display system are activated and deactivated at different frequencies than the light-sensing elements in the optical sensing region of the display system.

Another example display system of any preceding system is provided, wherein the display system includes a display, and the light-emitting elements in the display are scheduled for activation during more than one emission-off period per refresh update of the display. This system and related methods and storage media provide at least a technical benefit of faster response time to sensed light as compared to systems with single sensing periods per frame.

One or more example tangible processor-readable storage media embodied with instructions for executing on one or more processors and circuits of a computing device a process for reducing interference of one or more light-sensing elements of a display system by one or more light-emitting elements of the display system is provided. The process includes determining an emission schedule for the one or more light-emitting elements in an optical sensing region of the display system to include one or more emission periods and one or more emission-off periods, wherein the one or more light-emitting elements emit light within the optical sensing region during an emission period and do not emit light within the optical sensing region during an emission-off period. The process also includes generating a synchronization signal to drive the one or more light-emitting elements of the display system and triggering, based at least in part on the emission schedule, light sensing by the one or more light-sensing elements in the optical sensing region, wherein the light sensing by the light-sensing elements in the optical sensing region is triggered to be performed during the emission-off period.

One or more other example tangible processor-readable storage media of any preceding media is provided, wherein the display system includes a cover glass and the one or more light-emitting elements of the display system within the optical sensing region of the display system are positioned between the cover glass and the light-sensing elements of the display system.

One or more other example tangible processor-readable storage media of any preceding media is provided, wherein the display system includes at least one display having a stack of components, and the one or more light-emitting elements and the one or more light-sensing elements of the display within the optical sensing region of the display are positioned in a same layer of the stack.

One or more other example tangible processor-readable storage media of any preceding media is provided, wherein the display system includes at least two displays, and the light-emitting elements and the light-sensing elements in the optical sensing region of each display are controlled based at least in part on the synchronization signal.

One or more other example tangible processor-readable storage media of any preceding media is provided, wherein the light-emitting elements in the optical sensing region of the display system are activated and deactivated at different frequencies than the light-sensing elements in the optical sensing region of the display system.

One or more other example tangible processor-readable storage media of any preceding media is provided, wherein the display system includes a display, and the light-emitting elements in the display are scheduled for activation during more than one emission-off period per refresh update of the display.

An example system for reducing interference of one or more light-sensing elements of a display system by one or more light-emitting elements of the display system is provided. The system includes means for determining an emission schedule for the one or more light-emitting elements in an optical sensing region of the display system to include one or more emission periods and one or more emission-off periods, wherein the one or more light-emitting elements emit light within the optical sensing region during an emission period and do not emit light within the optical sensing region during an emission-off period. The system also means for includes generating a synchronization signal to drive the one or more light-emitting elements of the display system and means for triggering, based at least in part on the emission schedule, light sensing by the one or more light-sensing elements in the optical sensing region, wherein the light sensing by the light-sensing elements in the optical sensing region is triggered to be performed during the emission-off period.

Another example system of any preceding system is provided, wherein the display system includes at least one display having a stack of components, the stack of components including a cover glass and the one or more light-emitting elements, wherein the cover glass and the one or more light-emitting elements of the stack within the optical sensing region of the at least one display are positioned between the cover glass and the light-sensing elements of the at least one display.

Another example system of any preceding system is provided, wherein the display system includes at least one display having a stack of components, and the one or more light-emitting elements and the one or more light-sensing elements within the optical sensing region of the at least one display are positioned in a same layer of the stack.

Another example system of any preceding system is provided, wherein the display system includes at least two displays, and the light-emitting elements and the light-sensing elements in the optical sensing region of each display are controlled based at least in part on the synchronization signal.

Another example system of any preceding system is provided, wherein the display system includes at least a first display and a second display, and the light-sensing elements in the optical sensing region of the first display are triggered at a different time than the light-sensing elements in the optical sensing region of the second display.

Another example system of any preceding system is provided, wherein the light-emitting elements in the optical sensing region of the display system are activated and deactivated at different frequencies than the light-sensing elements in the optical sensing region of the display system.

Another example system of any preceding system further includes means for triggering, based at least in part on the emission schedule, light emission by one or more secondary light-emitting elements of the display system, wherein the light emission by the secondary light-emitting elements is triggered to be performed during the emission-off period.

Some implementations may comprise an article of manufacture. An article of manufacture may comprise a tangible storage medium to store logic. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of reducing interference of one or more light-sensing elements of a display system by one or more light-emitting elements of the display system, the method comprising:
determining an emission schedule for the one or more light-emitting elements in an optical sensing region of the display system to include one or more emission periods and one or more emission-off periods, wherein the one or more light-emitting elements emit light within the optical sensing region during an emission period and do not emit light within the optical sensing region during an emission-off period;
generating a synchronization signal to drive the one or more light-emitting elements of the display system; and
triggering, based at least in part on the emission schedule, light sensing by the one or more light-sensing elements in the optical sensing region, wherein the light sensing by the light-sensing elements in the optical sensing region is triggered to be performed during the emission-off period.

2. The method of claim 1, wherein the display system includes at least one display having a stack of components, the stack of components including a cover glass and the one or more light-emitting elements, wherein the cover glass and the one or more light-emitting elements of the stack within the optical sensing region of the at least one display are positioned between the cover glass and the light-sensing elements of the at least one display.

3. The method of claim 1, wherein the display system includes at least one display having a stack of components, and the one or more light-emitting elements and the one or more light-sensing elements within the optical sensing region of the at least one display are positioned in a same layer of the stack.

4. The method of claim 1, wherein the display system includes at least two displays, and the light-emitting elements and the light-sensing elements in the optical sensing region of each display are controlled based at least in part on the synchronization signal.

5. The method of claim 1, wherein the display system includes at least a first display and a second display, and the light-sensing elements in the optical sensing region of the first display are triggered at a different time than the light-sensing elements in the optical sensing region of the second display.

6. The method of claim 1, wherein the light-emitting elements in the optical sensing region of the display system are activated and deactivated at different frequencies than the light-sensing elements in the optical sensing region of the display system.

7. The method of claim 1, further comprising:
triggering, based at least in part on the emission schedule, light emission by one or more secondary light-emitting elements of the display system, wherein the light emission by the secondary light-emitting elements is triggered to be performed during the emission-off period.

8. A display system comprising:
one or more light-sensing elements within an optical sensing region of the display system;
one or more light-emitting elements within the optical sensing region of the display system;
a timing generator including circuitry configured to generate a synchronization signal to drive the one or more light-emitting elements; and
a display controller including circuitry configured to determine an emission schedule for the one or more light-emitting elements in the optical sensing region to include one or more emission periods and one or more emission-off periods, wherein the one or more light-emitting elements emit light within the optical sensing region during an emission period and do not emit light within the optical sensing region during an emission-off period, wherein light sensing by the one or more light-sensing elements in the optical sensing region is triggered, based at least in part on the emission schedule, to be performed during the emission-off period.

9. The display system of claim 8, wherein the display system includes at least one display having a stack of components, the stack of components including a cover glass and the one or more light-emitting elements, wherein the cover glass and the one or more light-emitting elements of the stack within the optical sensing region of the at least one display are positioned between the cover glass and the light-sensing elements of the at least one display.

10. The display system of claim 8, wherein the display system includes at least one display having a stack of components, and the one or more light-emitting elements and the one or more light-sensing elements within the optical sensing region of the at least one display are positioned in a same layer of the stack.

11. The display system of claim 8, wherein the display system includes at least two displays, and the light-emitting elements and the light-sensing elements in the optical sensing region of each display are controlled based at least in part on the synchronization signal.

12. The display system of claim 8, wherein the display system includes at least a first display and a second display, and the light-sensing elements in the optical sensing region of the first display are triggered at a different time than the light-sensing elements in the optical sensing region of the second display.

13. The display system of claim 8, wherein the light-emitting elements in the optical sensing region of the display system are activated and deactivated at different frequencies than the light-sensing elements in the optical sensing region of the display system.

14. The display system of claim 8, wherein the display system includes a display, and the light-emitting elements in the display are scheduled for activation during more than one emission-off period per refresh update of the display.

15. One or more tangible processor-readable storage media embodied with instructions for executing on one or more processors and circuits of a computing device a process for reducing interference of one or more light-sensing elements of a display system by one or more light-emitting elements of the display system, the process comprising:
determining an emission schedule for the one or more light-emitting elements in an optical sensing region of the display system to include one or more emission periods and one or more emission-off periods, wherein the one or more light-emitting elements emit light within the optical sensing region during an emission period and do not emit light within the optical sensing region during an emission-off period;
generating a synchronization signal to drive the one or more light-emitting elements of the display system; and
triggering, based at least in part on the emission schedule, light sensing by the one or more light-sensing elements in the optical sensing region, wherein the light sensing by the light-sensing elements in the optical sensing region is triggered to be performed during the emission-off period.

16. The one or more tangible processor-readable storage media of claim 15, wherein the display system includes a cover glass and the one or more light-emitting elements of the display system within the optical sensing region of the display system are positioned between the cover glass and the light-sensing elements of the display system.

17. The one or more tangible processor-readable storage media of claim 15, wherein the display system includes at least one display having a stack of components, and the one or more light-emitting elements and the one or more light-sensing elements of the display within the optical sensing region of the display are positioned in a same layer of the stack.

18. The one or more tangible processor-readable storage media of claim 15, wherein the display system includes at least two displays, and the light-emitting elements and the light-sensing elements in the optical sensing region of each display are controlled based at least in part on the synchronization signal.

19. The one or more tangible processor-readable storage media of claim 15, wherein the light-emitting elements in the optical sensing region of the display system are activated and deactivated at different frequencies than the light-sensing elements in the optical sensing region of the display system.

20. The one or more tangible processor-readable storage media of claim 15, wherein the display system includes a display, and the light-emitting elements in the display are scheduled for activation during more than one emission-off period per refresh update of the display.
